(19) United States
(12) Patent Application Publication
(10) Pub. No.: US 2018/0230401 A1
(43) Pub. Date: Aug. 16, 2018

(54) SILICONE SURFACTANT, AND SILICONE-DISSOLVATIVE CLEANER CONTAINING THE SAME

(71) Applicant: DAICEL CORPORATION, Osaka (JP)

(72) Inventors: Yuichi SAKANISHI, Tokyo (JP); Dingding LIU, Shanghai (CN)

(73) Assignee: DAICEL CORPORATION, Osaka (JP)

(21) Appl. No.: 15/866,126

(22) Filed: Jan. 9, 2018

(30) Foreign Application Priority Data
Feb. 16, 2017 (CN) PCT/CN2017/073770

(51) Int. Cl. C11D 1/82; C11D 1/86; C11D 3/04; C11D 3/18; C11D 3/24; C11D 3/43; C11D 11/00

(52) U.S. Cl. CPC C11D 1/82; C11D 1/86; C11D 3/042; C11D 11/0023; C11D 3/245; C11D 3/43; C11D 3/18

(57) ABSTRACT

Provided are: a novel compound that has excellent activity of dissolving a silicone compound and thereby solubilizing the silicone compound in an organic solvent; and a cleaner that contains the compound and can completely and rapidly remove the silicone compound deposited/remained on a mold and/or a molded article obtained using the mold. The novel compound is represented by Formula (1). The silicone-dissolvative cleaner contains (A) a silicone surfactant represented by Formula (1); and (B) an organic solvent. Formula (1) is expressed as follows:

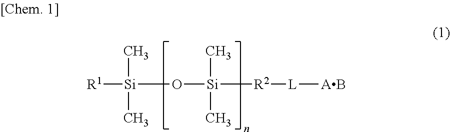

wherein “A” represents an ionic group selected from the group consisting of a sulfonic ion, a carboxylic ion, and a quaternary ammonium cation; and B represents a counter-ion to “A” and is selected from an alkali metal ion and a halide ion.

### TECHNICAL FIELD

The present invention relates to a novel silicone surfactant which has an excellent activity of decomposing and solubilizing silicone compounds. The present invention also relates to a cleaner which contains the silicone surfactant and which is used for removing silicone compounds deposited/remained on a mold and/or on a molded article obtained using the mold.

### BACKGROUND ART

Silicone compounds excel in water resistance, water repellency, heat resistance, weatherability, and chemical resistance and are therefore used in a wide variety of fields represented by chemical industry. For example, in the field of molding, such a silicone compound is used as a mold release agent for easy demolding of a molded article from a mold.

However, the silicone compound applied onto the mold tends to be deposited on (attached to) the molded article. The silicone compound, if remaining as deposited on the molded article upon coating of the molded article, causes the coating film to tend to be detached from the molded article surface. To eliminate or minimize this, the silicone compound has to be removed completely from the molded article surface. In addition, the silicone compound applied on the mold, if remaining and being deposited and solidified on the mold, causes deterioration in molding accuracy. To eliminate or minimize this, the silicone compound remained on the mold after molding also has to be removed.

In a known technique to remove a silicone compound, the silicone compound is removed by mechanical polishing. With this technique, however, it is very difficult to remove the silicone compound alone completely without adversely affecting the shape of the molded article. In addition, when the mold has a complicated shape, it is very difficult to remove the deposited silicone compound from the mold completely by mechanical polishing.

In other known techniques to remove a silicone compound, the molded article and/or the mold is immersed in a cleaner containing a surfactant and an organic solvent to dissolve the silicone compound in the cleaner and to remove the same from the molded article and/or the mold. For example, Patent Literature (PTL) 1 describes that a silicone compound can be dissolved and removed by immersing the silicone compound in a cleaner for 16 hours, where the cleaner includes dodecylbenzenesulfonic acid as the surfactant, and one of benzene, toluene, and hexane as the organic solvent. Disadvantageously, however, this technique takes an excessively long time to dissolve and remove the silicone compound and has low production efficiency.

PTL 2 describes a cleaner containing dodecylbenzenesulfonic acid as the surfactant, and at least one of isopropyl bromide and n-propyl bromide as the organic solvent. This technique, however, takes 15 minutes or longer to dissolve and remove the silicone compound and is still insufficient in production efficiency.

### CITATION LIST

### Patent Literature

PTL 1: Japanese Unexamined Patent Application Publication (JP-A) No. H04-318075

PTL 2: JP-A No. 2001-329295

### SUMMARY OF INVENTION

### Technical Problem

Accordingly, the present invention has an object to provide a novel silicone surfactant which has an excellent activity of decomposing a silicone compound and thereby solubilizing the silicone compound in an organic solvent.

The present invention has another object to provide a cleaner which can remove a silicone compound completely and rapidly, where the silicone compound has been deposited/remained (i.e., deposited or remained) on a mold or on a molded article obtained using the mold.

The present invention has still another object to provide a method for producing a molded article, where the method includes the step of cleaning the molded article and/or a mold on which a silicone compound is deposited/remained, using the cleaner.

### Solution to Problem

To achieve the objects, the inventors of the present invention found that a silicone surfactant having a specific structure is capable of satisfactorily decomposing a silicone compound into fragments having solubility in an organic solvent (namely, is capable of satisfactorily solubilizing a silicone compound in an organic solvent); and that a cleaner including the silicone surfactant and an organic solvent rapidly decomposes and dissolves a silicone compound deposited/remained on a mold and/or on a molded article obtained using the mold, can thereby completely remove the silicone compound, and can shorten the time necessary for cleaning as compared with conventional equivalents. The present invention has been made on the basis of these findings.

Specifically, the present invention provides, in an embodiment, a compound represented by Formula (1):

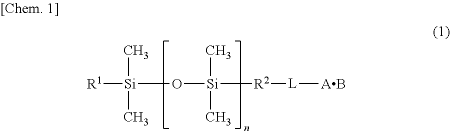

wherein R¹ represents a C₁-C₁₂ monovalent aliphatic hydrocarbon group; R² represents a C₁-C₁₂ divalent aliphatic hydrocarbon group; n represents an integer of 0 to 10; L is selected from a single bond and a linkage group; “A” represents an ionic group selected from the group consisting of a sulfonic ion, a carboxylic ion, and a quaternary ammonium cation; and B represents a counter-ion to “A” and is selected from an alkali metal ion and a halide ion.

The present invention also provides, in another embodiment, a silicone-dissolvative cleaner including (A) a compound represented by Formula (1), and (B) an organic solvent. Formula (1) is expressed as follows:

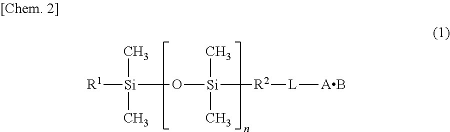

wherein R² represents a C₁-C₁₂ monovalent aliphatic hydrocarbon group; R² represents a C₁-C₁₂ divalent aliphatic hydrocarbon group; n represents an integer of 0 to 10; L is selected from a single bond and a linkage group; “A” represents an ionic group selected from the group consisting of a sulfonic ion, a carboxylic ion, and a quaternary ammonium cation; and B represents a counter-ion to “A” and is selected from an alkali metal ion and a halide ion.

In the silicone-dissolvative cleaner, the component (A) may be present in a content of 1 to 60 weight percent of the totality of the silicone-dissolvative cleaner.

The silicone-dissolvative cleaner may further include (C) a fluorine compound in a content of 0.001 to 10 weight percent of the totality of the silicone-dissolvative cleaner.

The fluorine compound in the silicone-dissolvative cleaner may be at least one of hydrogen fluoride and a salt thereof.

The organic solvent in the silicone-dissolvative cleaner may be at least one of a hydrocarbon and a halogenated hydrocarbon.

The present invention also provides, in yet another embodiment, a method for producing a molded article using a mold coated with a silicone compound. The method includes the step of cleaning at least one of the resulting molded article and the mold after use, using the silicone-dissolvative cleaner.

Specifically, the present invention relates to the following:

(1) A compound represented by Formula (1):

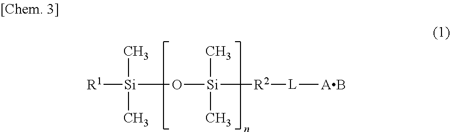

wherein R¹ represents a C₁-C₁₂ monovalent aliphatic hydrocarbon group; R² represents a C₁-C₁₂ divalent aliphatic hydrocarbon group; n represents an integer of 0 to 10; L is selected from a single bond and a linkage group; “A” represents an ionic group selected from the group consisting of a sulfonic ion, a carboxylic ion, and a quaternary ammonium cation; and B represents a counter-ion to “A” and is selected from an alkali metal ion and a halide ion.

(2) The compound according to (1), which is at least one of a compound represented by Formula (1-1) and a compound represented by Formula (1-2):

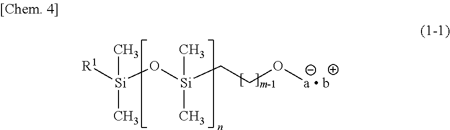

wherein R¹ represents a C₁-C₁₂ monovalent aliphatic hydrocarbon group; “a⁻” is selected from a sulfonic ion and a carboxylic ion; “b⁺” represents an alkali metal ion; m represents an integer of 1 to 12; and n represents an integer of 0 to 10,

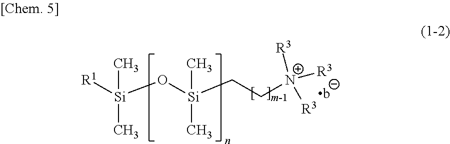

wherein R¹ represents a C₁-C₁₂ monovalent aliphatic hydrocarbon group; R³ is selected from alkyl and aryl; “b⁻” represents a halide ion; m represents an integer of 1 to 12; and n represents an integer of 0 to 10.

(3) The compound according to (1), which is at least one of the compound represented by (1-1) in which “a⁻” in the formula is a sulfonic ion, and the compound represented by Formula (1-2).

(4) A silicone-dissolvative cleaner containing (A) a compound represented by Formula (1) (preferably, the compound according to one of (2) and (3)); and (B) an organic solvent.

(5) The silicone-dissolvative cleaner according to (4), in which the component (A) is present in a content of 1 to 60 weight percent (preferably 1 to 30 weight percent, particularly preferably 1 to 15 weight percent, and most preferably from greater than 2 weight percent to 10 weight percent), of the totality of the silicone-dissolvative cleaner.

(6) The silicone-dissolvative cleaner according to one of (4) and (5), further containing (C) a fluorine compound in a content of 0.001 to 10 weight percent (preferably 0.01 to 5 weight percent, particularly preferably 0.05 to 1 weight percent, and most preferably 0.05 to 0.5 weight percent), of the totality of the silicone-dissolvative cleaner.

(7) The silicone-dissolvative cleaner according to (6), in which the fluorine compound is at least one of hydrogen fluoride and a salt thereof.

(8) The silicone-dissolvative cleaner according to (6), in which the fluorine compound is at least one selected from the group consisting of hydrogen fluoride, ammonium acid fluoride, ammonium fluoride, ammonium fluorosilicate, and ammonium fluoroborate.

(9) The silicone-dissolvative cleaner according to (6), in which the fluorine compound is at least one of hydrogen fluoride and ammonium acid fluoride.

(10) The silicone-dissolvative cleaner according to any one of (4) to (9), in which the organic solvent is at least one of a hydrocarbon and a halogenated hydrocarbon.

(11) The silicone-dissolvative cleaner according to any one of (4) to (10), in which the organic solvent contains a halogenated hydrocarbon.

(12) The silicone-dissolvative cleaner according to any one of (4) to (10), in which the organic solvent contains a halogenated C₁-C₁₀ (preferably C₁-C₅) aliphatic hydrocarbon.

(13) The silicone-dissolvative cleaner according to any one of (4) to (12), in which the component (A) is present in a proportion of 60 weight percent or more (preferably 70 weight percent or more, particularly preferably 80 weight percent or more, especially preferably 90 weight percent or more, and most preferably 95 weight percent or more), of the totality of compounds having surface activity and being contained in the silicone-dissolvative cleaner.

(14) The silicone-dissolvative cleaner according to any one of (4) to (13), in which the component (B) is present in a content of 40 to 99 weight percent (preferably 50 to 98.9 weight percent, particularly preferably 60 to 98 weight percent, especially preferably 70 to 97 weight percent, and most preferably 80 to 97 weight percent), of the totality of the silicone-dissolvative cleaner.

(15) The silicone-dissolvative cleaner according to any one of (11) to (14), in which the halogenated hydrocarbon (preferably halogenated C₁-C₁₀ aliphatic hydrocarbon, particularly preferably halogenated C₁-C₅ aliphatic hydrocarbon) is present in a content of 40 to 99 weight percent (preferably 50 to 98.9 weight percent, particularly preferably 60 to 98 weight percent, especially preferably 70 to 97 weight percent, and most preferably 80 to 97 weight percent), of the totality of the silicone-dissolvative cleaner.

(16) The silicone-dissolvative cleaner according to any one of (10) to (15), in which the halogenated hydrocarbon (preferably halogenated C₁-C₁₀ aliphatic hydrocarbon, particularly preferably halogenated C₁-C₅ aliphatic hydrocarbon) is present in a proportion of 60 weight percent or more (preferably 70 weight percent or more, particularly preferably 80 weight percent or more, especially preferably 90 weight percent or more, and most preferably 95 weight percent or more), of the totality of organic solvents contained in the silicone-dissolvative cleaner.

(17) The silicone-dissolvative cleaner according to any one of (6) to (16), in which the silicone-dissolvative cleaner has a total proportion of the component (A), the component (B), and the component (C) of 60 weight percent or more (preferably 70 weight percent or more, particularly preferably 80 weight percent or more, especially preferably 90 weight percent or more, and most preferably 95 weight percent or more), of the totality (100 weight percent) of the silicone-dissolvative cleaner.

(18) A method for producing a molded article using a mold coated with a silicone compound, the method including the step of cleaning at least one of the resulting molded article and the mold after use, using the silicone-dissolvative cleaner according to any one of (4) to (17).

### Advantageous Effects of Invention

The compound represented by Formula (1) (i.e., the silicone surfactant) has an excellent activity of decomposing a silicone compound and thereby solubilizing the silicone compound in an organic solvent. The silicone-dissolvative cleaner according to the present invention, which contains the compound, has, in particular, excellent activity of decomposing, dissolving, and removing a silicone compound (i.e., has excellent cleaning power or detergency) and can shorten the time necessary for cleaning of the silicone compound, as compared with conventional equivalents. For example, the silicone-dissolvative cleaner enables the cleaning typically within 10 minutes or shorter, and preferably within 7 minutes or shorter. Thus, the silicone-dissolvative cleaner can contribute to dramatically better production efficiency.

In an embodiment, the silicone-dissolvative cleaner according to the present invention contains a halogenated hydrocarbon as the organic solvent. The silicone-dissolvative cleaner according to this embodiment is highly safe and is easy to handle, because such halogenated hydrocarbons have approximately no flammability.

The silicone-dissolvative cleaner according to the present invention can readily remove a silicone compound remaining on the mold and can restrain deterioration in molding accuracy of the mold, where the deterioration will be caused by deposition and/or solidification of the residual silicone compound.

In addition, the silicone-dissolvative cleaner according to the present invention can readily remove the silicone compound deposited on a molded article obtained using the mold. When a coating film is to be formed on the molded article, the silicone-dissolvative cleaner allows the resulting coating film to have better adhesion to the molded article surface and can eliminate or minimize the stripping (separation) of the coating film from the molded article.

### DESCRIPTION OF EMBODIMENTS

### Silicone Surfactant

The compound represented by Formula (1) is a compound having surface activity (namely, a silicone surfactant) and can satisfactorily decompose siloxane bonds (Si—O—Si) of a silicone compound into low-molecular-weight fragments and thereby allows the silicone compound to be soluble in an organic solvent. The compound represented by Formula (1) can decompose the silicone compound into such low-molecular-weight fragments as to be washed away with the organic solvent. Formula (1) is expressed as follows:

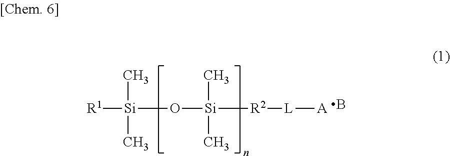

wherein R¹ represents a C₁-C₁₂ monovalent aliphatic hydrocarbon group; R² represents a C₁-C₁₂ divalent aliphatic hydrocarbon group; n represents an integer of 0 to 10; L is selected from a single bond and a linkage group; “A” represents an ionic group selected from the group consisting of a sulfonic ion, a carboxylic ion, and a quaternary ammonium cation; and B represents a counter-ion to “A” and is selected from an alkali metal ion and a halide ion.

Non-limiting examples of the C₁-C₁₂ monovalent aliphatic hydrocarbon group as R¹ include C₁-C₁₂ (preferably C₁-C₅, and particularly preferably C₁-C₃) linear or branched alkyls such as methyl, ethyl, propyl, isopropyl, butyl, isobutyl, s-butyl, t-butyl, pentyl, hexyl, decyl, and dodecyl; C₂⁻C₁₂ (preferably C₂-C₅, and particularly preferably C₂ or C₃) linear or branched alkenyls such as vinyl, allyl, and 1-butenyl; and C₂-C₁₂ (preferably C₂-C₅, and particularly preferably C₂ or C₃) linear or branched alkynyls such as ethynyl and propynyl.

Among them, R¹ is preferably selected from C₁-C₁₂ (more preferably C₁-C₅, and particularly preferably C₁-C₃) linear or branched alkyls, and is particularly preferably methyl.

Non-limiting examples of the C₁-C₁₂ divalent aliphatic hydrocarbon group as R² include C₁-C₁₂ linear or branched alkylenes such as methylene, methylmethylene, dimethylmethylene, ethylene, propylene, and trimethylene; C₂-C₁₂ linear or branched alkenylenes such as vinylene, propenylene, 1-butenylene, 2-butenylene, butadienylene, pentenylene, hexenylene, heptenylene, and octenylene; and C₂-C₁₂ linear or branched alkynylenes such as propynylene.

Among them, R² is preferably selected from C₁-C₁₂ (more preferably C₃-C₁₂, particularly preferably C₄-C₁₁, and most preferably C₄-C₉) linear or branched alkylenes.

The repetition number n represents an integer of 0 to 10 and is an integer of preferably 1 to 8, particularly preferably 2 to 6, and most preferably 3 to 5.

L is selected from a single bond and a linkage group. Non-limiting examples of the linkage group include carbonyl (—CO—), ether bond (—O—), thioether bond (—S—), ester bond (—COO—), amido bond (—CONH—), carbonate bond (—OCOO—), and groups each including two or more of them linked to each other.

“A” represents an ionic group selected from the group consisting of a sulfonic ion (—SC₃⁻), a carboxylic ion (—COO—), and a quaternary ammonium cation.

The quaternary ammonium cation is represented typically by —N(R³)₃⁺, where R³ is, identically or differently in each occurrence, selected from alkyl and aryl. The alkyl is preferably selected from C₁-C₃ alkyls such as methyl, ethyl, propyl, and isopropyl. The aryl is preferably selected from C₆-C₁₄ aryls such as phenyl.

B represents a counter-ion to the ion “A”. For example, when “A” is a sulfonic ion or a carboxylic ion, B is an alkali metal ion (such as Li⁺, Na⁺, or K⁺); and when “A” is a quaternary ammonium cation, B is a halide ion (such as F⁻, Cl⁻, Br⁻, or I⁻).

The compounds represented by Formula (1) include compounds in which L is an alkylene having “m” carbon atoms, where m represents an integer of 1 to 12; “A” is selected from a sulfonic ion and a carboxylic ion (such “A” is represented by “a⁻” in formulae below); and B is a counter-ion to “A” (namely, an alkali metal ion; such B is represented by “b⁺” in the formulae). These compounds can be produced typically by a method below. In the formulae, R¹ and n are as defined above.

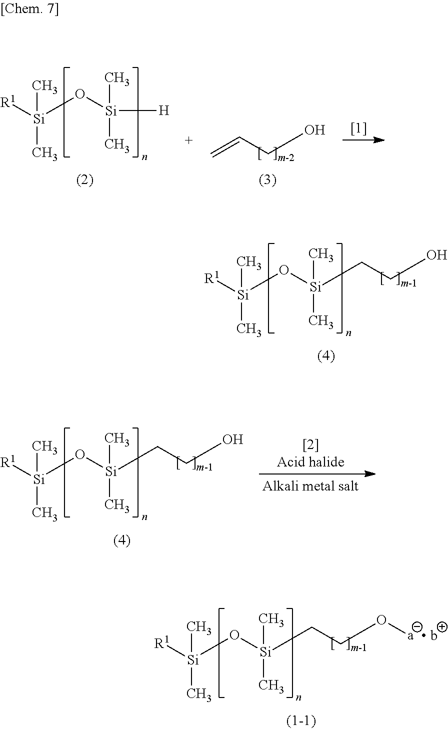

The reaction [1] is a reaction (hydrosilylation reaction) between a compound represented by Formula (2) and a compound represented by Formula (3) to give a compound represented by Formula (4). The compound represented by Formula (3) is used in an amount of typically 0.5 to 5 moles, and preferably 1 to 3 moles, per mole of the compound represented by Formula (2).

The reaction [1] is preferably performed in the presence of a platinum catalyst (such as Karstedt catalyst; platinum(0)-1,3-divinyl-1,1,3,3-tetramethyldisiloxane complex).

The reaction [1] is preferably performed in the presence of a solvent. Preferred, but non-limiting examples of the solvent include aromatic hydrocarbon solvents such as benzene, toluene, and xylenes. The solvent is preferably used in an amount of typically 2 times by weight or more the total amount of the reactants.

The reaction [1] is performed typically by adding the compound represented by Formula (2) dropwise to the compound represented by Formula (3) placed in a reactor. The reaction is performed at a reaction temperature (or temperature upon dropping) of typically about 50° C. to about 100° C. for a reaction time (or dropping time) of typically about 1 minute to about 30 minutes. The method may further include an aging step after the completion of the reaction [1] (or after the completion of dropping). In the aging step, the aging may be performed at a temperature of typically about 50° C. to about 100° C. for a time of typically about 1 to about 42 hours. The reaction can be performed in any system such as batch system, semi-batch system, or continuous system.

After the completion of the reaction [1], the resulting reaction product may be separated/purified typically by a separation means such as filtration, concentration, distillation, extraction, crystallization, adsorption, recrystallization, or column chromatography, or by separation means as any combination of them.

The reaction [2] is a reaction in which the compound represented by Formula (4), which is obtained through the reaction [1], is reacted with an acid halide, and then an alkali metal salt is added for neutralization, to give the compound represented by Formula (1-1). The acid halide is exemplified typically by sulfonic halides such as chlorosulfonic acid; and carbonyl halides such as carbonyl chloride. The alkali metal salt is exemplified typically by alkali metal hydrogencarbonates such as sodium hydrogencarbonate. Assume that the compound represented by Formula (4) is reacted with a carbonyl halide as the acid halide. In particular in this case, the method preferably further includes a hydrolysis step before the addition of the alkali metal salt for neutralization. In the hydrolysis step, a base such as sodium hydroxide is reacted for hydrolysis.

The acid halide is used in an amount of typically 0.5 to 3 moles, and preferably 0.5 to 2 moles, per mole of the compound represented by Formula (4). The alkali metal salt is used in an amount of typically 0.5 mole or more per mole of the compound represented by Formula (4), and may be used in an excessive amount.

The reaction [2] is preferably performed in the presence of a solvent. Preferred, but non-limiting examples of the solvent include halogenated hydrocarbon solvents such as methylene chloride, chloroform, 1,2-dichloroethane, chlorobenzene, and bromobenzene. The solvent is preferably used in an amount of typically 5 times by weight or more the total amount of the reactants.

The reaction [2] is performed at a temperature of typically about −10° C. to about 10° C. for a time of typically about 0.5 to about 5 hours. The reaction can be performed in any system such as batch system, semi-batch system, or continuous system.

After the completion of the reaction [2], the resulting reaction product may be separated/purified typically by a separation means such as filtration, concentration, distillation, extraction, crystallization, adsorption, recrystallization, or column chromatography, or by a separation means as any combination of them.

The compounds represented by Formula (1) include compounds in which L is an alkylene having “m” carbon atoms, where m represents an integer of 1 to 12; “A” is a quaternary ammonium cation —N(R³)₃⁺, where R³ is as defined above; and B represents a counter-ion to “A” (namely, a halide ion; which is represented by “b⁻” in the following formulae). These compounds can each be produced typically by the following method. In the formulae, b represents halogen; and R¹, R³, and n are as defined above.

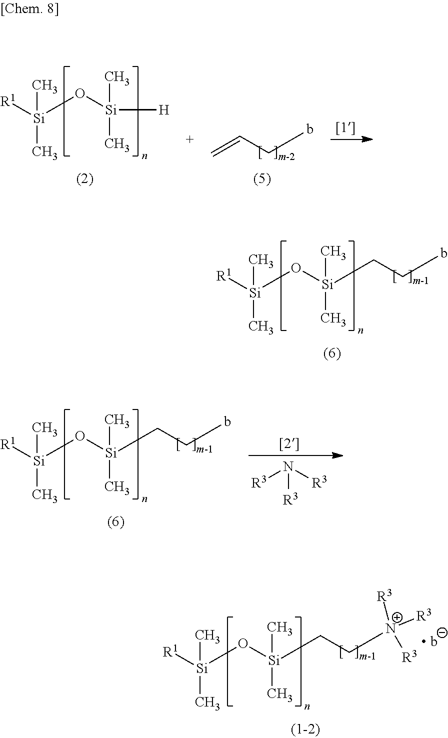

The reaction [1′] is a reaction (hydrosilylation reaction) between the compound represented by Formula (2) and a compound represented by Formula (5) to give a compound represented by Formula (6). The compound represented by Formula (5) is used in an amount of typically 0.2 to 3 moles, and preferably 0.3 to 2 moles, per mole of the compound represented by Formula (2).

The compound represented by Formula (5) can be produced typically by reacting the compound represented by Formula (3) with a halogenated succinimide, such as N-chlorosuccinimide, as a halogenating agent. This reaction is preferably performed in the presence of a phosphine compound. Non-limiting examples of the phosphine compound include triisopropylphosphine, tributylphosphine, triphenylphosphine, tris(4-methylphenyl)phosphine, and tris(3-methylphenyl)phosphine.

The reaction [1′] is preferably performed in the presence of a platinum catalyst (such as Karstedt catalyst; platinum (0)-1,3-divinyl-1,1,3,3-tetramethyldisiloxane complex).

The reaction [1′] is preferably performed in the presence of a solvent. Preferred, but non-limiting examples of the solvent include ether solvents such as diethyl ether, diisopropyl ether, dibutyl ether, tetrahydrofuran (THF), dioxane, 1,2-dimethoxyethane, and cyclopentyl methyl ether. The solvent is preferably used in an amount of typically 5 times by weight or more the total amount of the reactants. [0046]

The reaction [1′] is performed typically by adding the compound represented by Formula (2) dropwise to the compound represented by Formula (5) placed in a reactor. The reaction is performed at a reaction temperature (or temperature upon dropping) of typically about 50° C. to about 100° C. for a reaction time (or dropping time) of typically about 1 minute to about 30 minutes. The method may further include an aging step after the completion of the reaction [1′] (or after the completion of dropping). In the aging step, the aging may be performed at a temperature of typically about 50° C. to about 100° C. for a time of typically about 1 to about 42 hours. The reaction can be performed in any system such as batch system, semi-batch system, or continuous system.

After the completion of the reaction [1′], the resulting reaction product may be separated/purified typically by a separation means such as filtration, concentration, distillation, extraction, crystallization, adsorption, recrystallization, or column chromatography, or by a separation means as any combination of them.

The reaction [2′] is a reaction of the compound represented by Formula (6), which is obtained through the reaction [1′], with an amine N(R³)₃, where R³ is as defined above, to give the compound represented by Formula (1-2).

The amine is used in an amount of typically 0.5 mole or more per mole of the compound represented by Formula (6), and may be used in an excessive amount.

The reaction [2′] is preferably performed in the presence of a solvent. Preferred, but non-limiting examples of the solvent include alcoholic solvents such as methanol and ethanol. The solvent is preferably used in an amount of typically 5 times by weight or more the total amount of the reactants.

The reaction [2′] is performed at a temperature of typically about 50° C. to about 100° C. for a time of typically about 12 to about 72 hours. The reaction can be performed in any system such as batch system, semi-batch system, or continuous system.

After the completion of the reaction [2′], the resulting reaction product may be separated/purified typically by a separation means such as filtration, concentration, distillation, extraction, crystallization, adsorption, recrystallization, or column chromatography, or by a separation means as any combination of them.

### Silicone-Dissolvative Cleaner

The silicone-dissolvative cleaner (silicone-dissolvative detergent) according to the present invention contains components (A) and (B) as follows. The silicone-dissolvative cleaner according to the present invention may further contain one or more other components in addition to the components (A) and (B). For example, the silicone-dissolvative cleaner preferably further contains a component (C).

The component (A) is the compound represented by Formula (1) (i.e., silicone surfactant).

The component (B) is an organic solvent.

The component (C) is a fluorine compound.

Component (B): Organic Solvent

Non-limiting examples of the organic solvent for use in the present invention include aliphatic hydrocarbons such as pentane, hexane, heptane, and octane; ketones such as acetone, methyl ethyl ketone, methyl isobutyl ketone, cyclopentanone, and cyclohexanone; aromatic hydrocarbons such as benzene, toluene, xylenes, mesitylene, ethylbenzene, n-pentylbenzene, and tetramethylbenzene; halogenated hydrocarbons such as isopropyl bromide, n-propyl bromide, methylene chloride, chloroform, dichloromethane, 1,2-dichloroethane, trichloroethylene, tetrachloromethane, chlorobenzene, and bromobenzene; ethers such as diethyl ether, diisopropyl ether, dibutyl ether, tetrahydrofuran, dioxane, 1,2-dimethoxyethane, and cyclopentyl methyl ether; and esters such as ethyl acetate, butyl acetate, and propylene glycol methyl ether acetate.

Among them, the organic solvent preferably contains a halogenated hydrocarbon. This is preferred because such halogenated hydrocarbons have excellent solvent power on the compound represented by Formula (1), have approximately no flammability, and thereby offer excellent handleability.

Non-limiting examples of the halogenated hydrocarbon include halogenated C₁-C₁₀ (preferably C₁-C₅) aliphatic hydrocarbons such as isopropyl bromide, n-propyl bromide, methylene chloride, chloroform, dichloromethane, 1,2-dichloroethane, trichloroethylene, and tetrachloromethane; and halogenated C₆-C₁₄ (preferably C₆-C₁₀) aromatic hydrocarbons such as chlorobenzene and bromobenzene, as described above. Among them, halogenated C₁-C₁₀ (preferably C₁-C₅) aliphatic hydrocarbons are preferred because of having excellent cleaning power.

Component (C): Fluorine Compound

The fluorine compound for use in the present invention is a compound that can decompose a silicone compound to dissolve and remove the silicone compound. Non-limiting examples of the fluorine compound include hydrogen fluoride; and salts thereof (ammonium salts, alkali metal salts, and amine salts).

In particular, the fluorine compound for use in the present invention is preferably at least one of hydrogen fluoride and an ammonium salt thereof, for excellent cleaning power on silicone compounds. The fluorine compound is more preferably at least one selected typically from hydrogen fluoride (or hydrofluoric acid) (HF), ammonium acid fluoride (NH₄F.HF), ammonium fluoride (NH₄F), ammonium fluorosilicate ((NH₄)₂SiF₆), and ammonium fluoroborate (NH₄BF₄), and is especially preferably at least one of hydrogen fluoride and ammonium acid fluoride.

Silicone-Dissolvative Cleaner

The silicone-dissolvative cleaner according to the present invention can be prepared by mixing the component (A), the component (B), and as needed, the component (C) with one another. The silicone-dissolvative cleaner may contain each of different components (A), each of different components (B), and each of different components (C) as needed, alone or in combination.

The component (A) is present in a content of typically 1 to 60 weight percent, preferably 1 to 30 weight percent, particularly preferably 1 to 15 weight percent, and most preferably from greater than 2 weight percent to 10 weight percent, of the totality of the silicone-dissolvative cleaner. The silicone-dissolvative cleaner according to the present invention, when containing the component (A) in a content of 1 weight percent or more of the totality of the silicone-dissolvative cleaner, can offer excellent decomposing activity on a silicone compound and can rapidly dissolve and remove the silicone compound by cleaning within a short time. The silicone-dissolvative cleaner according to the present invention, when containing the component (A) in a content of 60 weight percent or less of the totality of the silicone-dissolvative cleaner, has a low viscosity and excellent fluidity, and enables efficient cleaning operations on silicone compounds.

The component (A) is present in a proportion of typically 60 weight percent or more, preferably 70 weight percent or more, particularly preferably 80 weight percent or more, especially preferably 90 weight percent or more, and most preferably 95 weight percent or more, of the totality of compounds having surface activity and being contained in the silicone-dissolvative cleaner according to the present invention. The upper limit of the proportion is 100 weight percent. In other words, in such compounds having surface activity and being contained in the silicone-dissolvative cleaner according to the present invention, compounds other than the component (A) is present in a proportion of typically 40 weight percent or less, preferably 30 weight percent or less, particularly preferably 20 weight percent or less, especially preferably 10 weight percent or less, and most preferably 5 weight percent or less, of the totality of the compounds. The lower limit of the proportion is zero. The silicone-dissolvative cleaner according to the present invention, when containing the component (A) in a proportion within the range, has particularly excellent cleaning power on a silicon compound, enables complete removal of the silicone compound by cleaning within a shorter time, and contributes to still better working efficiency.

The component (B) is present in a content of typically 40 to 99 weight percent, preferably 50 to 98.9 weight percent, particularly preferably 60 to 98 weight percent, especially preferably 70 to 97 weight percent, and most preferably. 80 to 97 weight percent, of the totality of the silicone-dissolvative cleaner. The silicone-dissolvative cleaner according to the present invention, when containing the component (B) in a content of 40 weight percent or more of the totality of the silicone-dissolvative cleaner, has a low viscosity and excellent fluidity and enables efficient cleaning operations on silicone compounds.

The halogenated hydrocarbon (such as halogenated C₁-C₁₀ (preferably C₁-C₅) aliphatic hydrocarbon) may be present in a content of typically 40 to 99 weight percent, preferably 50 to 98.9 weight percent, particularly preferably 60 to 98 weight percent, especially preferably 70 to 97 weight percent, and most preferably 80 to 97 weight percent, of the totality of the silicone-dissolvative cleaner. The silicone-dissolvative cleaner according to the present invention, when containing the halogenated hydrocarbon in a content of 40 weight percent or more of the totality of the silicone-dissolvative cleaner, has a low viscosity and excellent fluidity, and thereby enables efficient cleaning operations on silicone compounds.

The proportion of the halogenated hydrocarbon (such as halogenated C₁-C₁₀ (preferably C₁-C₅) aliphatic hydrocarbon) is typically 60 weight percent or more, preferably 70 weight percent or more, particularly preferably 80 weight percent or more, especially preferably 90 weight percent or more, and most preferably 95 weight percent or more, of the totality of the component (B) contained in the silicone-dissolvative cleaner according to the present invention. The upper limit of the proportion is 100 weight percent. In other words, the proportion of other organic solvents than the halogenated hydrocarbons is typically 40 weight percent or less, preferably 30 weight percent or less, particularly preferably 20 weight percent or less, especially preferably 10 weight percent or less, and most preferably 5 weight percent or less, of the totality of the component (B) contained in the silicone-dissolvative cleaner according to the present invention. The lower limit of the proportion is zero (0 weight percent). The silicone-dissolvative cleaner according to the present invention preferably contains the halogenated hydrocarbon in an amount within the range. This is preferred because this silicone-dissolvative cleaner has a low viscosity and excellent fluidity, thereby enables efficient cleaning operations on silicone compounds, and, in addition, has low flammability and excellent handleability.

The silicone-dissolvative cleaner according to the present invention preferably further contains the component (C) (such as at least one of hydrogen fluoride and ammonium acid fluoride), because this configuration allows the silicone-dissolvative cleaner to offer still better cleaning power on a silicone compound and to shorten the time necessary for the cleaning. The component (C) (such as at least one of hydrogen fluoride and ammonium acid fluoride) may be present in a content of typically 0.001 to 10 weight percent, preferably 0.01 to 5 weight percent, particularly preferably 0.05 to 1 weight percent, and most preferably 0.05 to 0.5 weight percent, of the totality of the silicone-dissolvative cleaner. The silicone-dissolvative cleaner according to the present invention preferably contains the component (C) in a content of 10 weight percent or less of the totality of the silicone-dissolvative cleaner, for surely having safety and for offering excellent handleability.

The total proportion (totality of the contents) of the component (A), the component (B), and the component (C) is typically 60 weight percent or more, preferably 70 weight percent or more, particularly preferably 80 weight percent or more, especially preferably 90 weight percent or more, and most preferably 95 weight percent or more, of the totality (100 weight percent) of the silicone-dissolvative cleaner according to the present invention. The upper limit of the total proportion is 100 weight percent.

### Molded Article Production Method

The method according to the present invention for producing a molded article is a method for producing a molded article using a mold coated with a silicone compound. The method includes the step of cleaning at least one of the resulting molded article and the mold after use, using the silicone-dissolvative cleaner.

The silicone compound in the present invention is an oligomer or polymer each including siloxane bonds (Si—O—Si) as a principal chain, and having one or more organic functional groups in a side chain or chains. Non-limiting examples of the organic functional groups include alkyls such as methyl; alkenyls such as vinyl; and aryls such as phenyl. The silicone compound may have any of structures such as chain (linear or branched), ladder, reticular, cyclic, complete cage (full cage), incomplete cage (partial cage), and cubic structures.

A silicone compound, when used as a mold release agent, is often deposited or remains on the mold and/or the resulting molded article, but is very hardly removed therefrom according to conventional techniques, because such silicone compounds have water resistance, water repellency, heat resistance, weatherability, and chemical resistance. However, the silicone-dissolvative cleaner according to the present invention has excellent cleaning power on a silicone compound and, when used in cleaning, can remove the silicone compound approximately completely within a short time.

A technique of cleaning the molded article and/or the mold after use using the silicone-dissolvative cleaner according to the present invention is not limited, but non-limiting examples of the technique include (1) a technique of rubbing the molded article and/or the mold after use typically with a sponge impregnated with the cleaner; (2) a technique of placing the cleaner in a bath, and immersing the molded article and/or the mold after use in the cleaner in the bath; and (3) a technique of blowing the cleaner against the molded article and/or the mold after use.

In particular, the technique (2) is preferred to perform the cleaning safely and efficiently. In the technique (2), the immersion treatment is performed for a time of typically preferably 10 minutes or shorter (e.g., 1 to 10 minutes), and particularly preferably 7 minutes or shorter (e.g., 3 to 7 minutes). The immersion treatment is performed at a cleaner temperature of typically 10° C. to 30° C., and preferably 15° C. to 25° C. The cleaner (cleaning liquid) herein is preferably stirred during the immersion treatment using, for example, a stirrer or an ultrasonic bath. This is preferred for further shortening the time necessary for cleaning.

After the cleaning using the silicone-dissolvative cleaner according to the present invention, the molded article and/or the mold after use may be rinsed typically with the organic solvent (in particular, halogenated C₁C₁₀ (preferably C₁-C₅) aliphatic hydrocarbon).

The method according to the present invention for producing a molded article can remove the silicone compound deposited or remained on the mold approximately completely in the cleaning step. Thus, the method can restrain deterioration in molding accuracy, where the deterioration will be caused by deposition and solidification of the silicone compound. The method enables continuous production of molded articles with high accuracy/precision even when the mold is used repeatedly.

The molded article obtained by the method according to the present invention for producing a molded article has undergone the cleaning step, and the silicone compound deposited on the molded article has been approximately completely removed from the molded article. The resulting molded article, when subjected to coating, can have a coating film having excellent adhesion.

### EXAMPLES

The present invention will be illustrated in further detail with reference to several examples below. It should be noted, however, that the examples are by no means intended to limit the scope of the present invention.

### Synthetic Example 1

### Synthesis of Silicone Surfactant (1-1a)

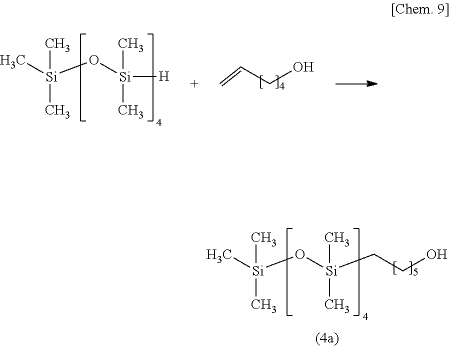

Hexen-1-ol (4.05 g, 40.5 mmol), Karstedt catalyst (5 g, 2000 ppm), and toluene (50 mL) were placed in a three-necked flask equipped with a dropping funnel and a thermometer.

After heating the system on an oil bath up to an internal temperature of 70° C., 1,1,1,3,3,5,5,7,7,9,9-undecamethylpentasiloxane (10 g, 27.0 mmol) was added dropwise over 10 minutes. The mixture was then raised in temperature up to 75° C., followed by aging for 18 hours. The mixture was cooled down to room temperature, from which the solvent was removed under reduced pressure, the residual mixture was purified by chromatography, and yielded an intermediate (11.2 g) represented by Formula (4a).

¹H-NMR (400 MHz, CDCl₃): δ 3.64-3.83 (t, 2H), 1.58-1.62 (m, 2H), 1.36-1.37 (m, 8H), 0.85 (t, 9H), 0.57-0.60 (m, 2H), 0.11-0.19 (m, 45H).

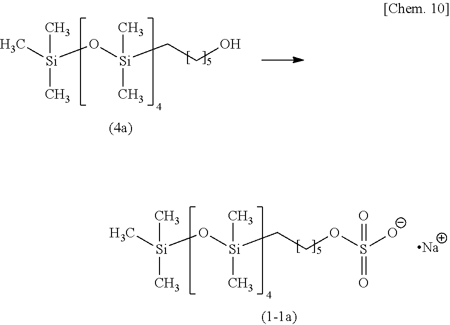

The prepared intermediate (5 g, 10.6 mmol) and dichloromethane (100 mL) were placed in a 250-mL flask, and chlorosulfonic acid (1.23 g, 10.6 mmol) was added at 0° C.

After being reacted for 1.5 hours, the mixture was neutralized with a saturated aqueous solution of sodium hydrogencarbonate, followed by separation of an aqueous layer. Water was removed from the aqueous layer under reduced pressure, the residue was washed with ethanol, was further dried, and yielded a silicone surfactant (500 mg) represented by Formula (1-1a).

¹H-NMR (400 MHz, D₂O): δ 3.81-3.90 (t, 2H), 1.49-1.60 (m, 2H), 1.20-1.31 (m, 5H), 0.40-0.49 (m, 2H), -0.11-0.00 (m, 11H).

### Synthetic Example 2

### Synthesis of Silicone Surfactant (1-1b)

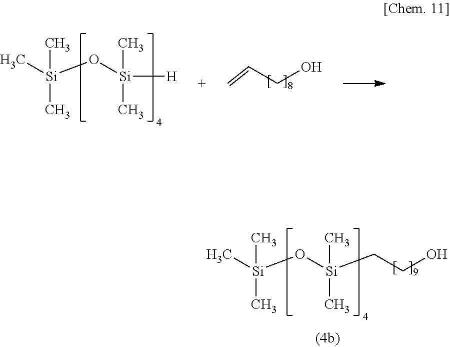

An intermediate represented by Formula (4b) (14.5 g) was prepared by a procedure similar to that in Synthetic Example 1, except for using decen-1-ol (6.32 g, 40.5 mmol) instead of hexen-1-ol.

¹H-NMR (400 MHz, CDCl₃): δ 3.68-3.64 (t, 2H), 1.58-1.62 (m, 2H), 1.33-1.29 (m, 16H), 0.90 (t, 2H), 0.57-0.60 (m, 2H), 0.11-0.19 (m, 52H).

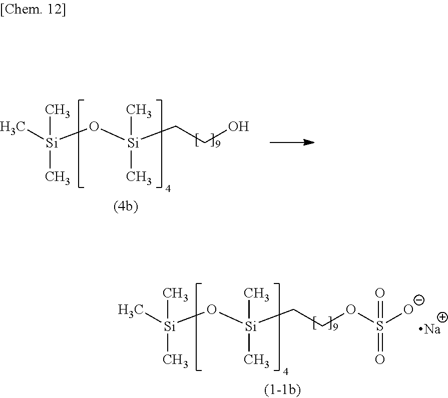

A silicone surfactant represented by Formula (1-1b) (2 g) was prepared by a procedure similar to that in Synthetic Example 1, except for using the intermediate represented by Formula (4b) (12 g, 22.8 mmol) instead of the intermediate represented by Formula (4a); using dichloromethane in an amount of 150 mL; and using chlorosulfonic acid in an amount of 2.65 g (22.7 mmol).

¹H-NMR (400 MHz, D₂O): δ 3.81-3.90 (t, 2H), 1.49-1.60 (m, 2H), 1.20-1.31 (m, 5H), 0.40-0.49 (m, 2H), -0.11-0.00 (m, 11H).

### Synthetic Example 3

### Synthesis of Silicone Surfactant (1-2c)

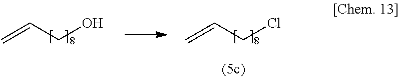

Triphenylphosphine (9.92 g, 35 mol) and THF (100 mL) were placed in a three-necked flask equipped with a dropping funnel and a thermometer. A solution of N-chlorosuccinimide (4.68 g, 35 mmol) in THF (10 mL) was then added dropwise over 10 minutes.

The mixture was stirred at room temperature for 5 minutes, and a solution of 9-decen-1-ol (5 g, 32 mmol) in THF (10 mL) was added dropwise. After aging at room temperature for 18 hours, the solvent was removed under reduced pressure, and the residue was combined with hexane and water. An aqueous layer was separated from the mixture, was concentrated, and yielded 10-chloro-1-decene represented by Formula (5c) (5 g).

¹H-NMR (400 MHz, CDCl₃): δ 5.74-5.85 (m, 1H), 4.90-5.12 (m, 2H), 3.52 (t, 2H), 2.01-2.08 (m, 2H), 1.72-1.80 (m, 2H), 1.20-1.45 (m, 10H).

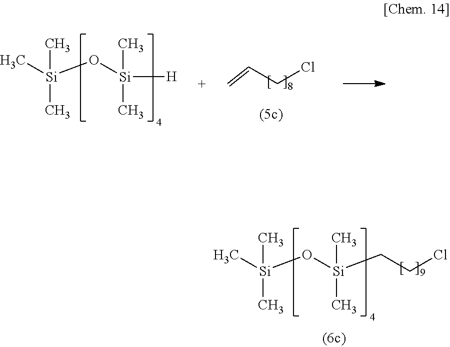

In a three-necked flask equipped with a dropping funnel and a thermometer, 10-chloro-1-decene (1.38 g, 7.9 mmol), Karstedt catalyst (5 drops/2% solution), and THF (50 mL) were placed.

The system internal temperature was raised up to 70° C., 1,1,1,3,3,5,5,7,7,9,9-undecamethylpentasiloxane (5 g, 13 mmol) was added dropwise over 10 minutes, and the mixture was reacted at 75° C. for 18 hours. The reaction mixture was cooled down to room temperature, from which the solvent was removed under reduced pressure, the residue was purified by chromatography, and yielded an intermediate represented by Formula (6c) (5.1 g).

¹H-NMR (400 MHz, CDCl₃): δ 3.49-3.55 (t, 2H), 1.71-1.82 (m, 2H), 1.18-1.46 (m, 14H), 0.48-0.55 (m, 2H), 0.01-0.11 (m, 35H).

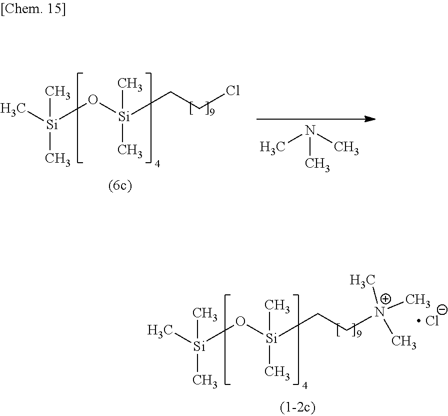

The intermediate (5 g, 10 mmol) and a solution of trimethylamine in ethanol were placed in a round-bottomed flask, the system internal temperature was raised up to 80° C., and the mixture was stirred for 3 days. The mixture was then cooled down to room temperature, from which the solvent was removed under reduced pressure, the residue was purified, and yielded a silicone surfactant represented by Formula (1-2c) (1 g).

¹H-NMR (400 MHz, D₂O): δ 3.42-3.51 (m, 2H), 3.40 (s, 9H), 1.66-1.78 (m, 2H), 1.20-1.42 (m, 12H), 0.44-0.54 (m, 2H), 0.01-0.09 (m, 30H).

### Examples 1 to 8 and Comparative Examples 1 and 2

Cleaners were prepared by mixing components according to the formulations (in weight percent) given in the table below. The silicone surfactants prepared in the synthetic examples were each used as the silicone surfactant herein.

The cleaning power (detergency) of the cleaners prepared in the examples and the comparative examples was examined by evaluating coating film adhesion. This evaluation utilizes the fact that coating film adhesion decreases if the silicone compound remains after cleaning or is redeposited.

Detergency Evaluation

Test specimens were each prepared by coating an epoxy resin substrate with dimethylsilicone oil (200 g/m²) as a silicone compound and subsequently baking at 175° C. for 2 minutes.

The prepared test specimens were immersed in the cleaners obtained in the examples and the comparative examples at a cleaner temperature of 20° C. for 5 minutes, then immersed in n-propyl bromide as a rinse agent for 3 minutes, and dried by air blowing.

The dried test specimens after the cleaning were coated with an acrylic urethane resin coating material (200 g/m²), then baked at 80° C. for 30 minutes, and yielded test specimens bearing a coating film.

The prepared test specimens bearing a coating film were subjected to 1-mm square cross-cut adhesion tests (in conformity with JIS K 5600-5-6:1999), pieces of the coating film which remained without separation or stripping were counted, on the basis of which adhesion was evaluated according to criteria as follows:

Evaluation Criteria
Good: having a coating film adhesion rate of 95% or more
Fair: having a coating film adhesion rate of 50% to less than 95%
Poor: having a coating film adhesion rate of 1% to less than 50%
Very poor: having coating film adhesion rate of less than 1%

TABLE 1

| | | | | | | | | | | Comparative | |
|---|---|---|---|---|---|---|---|---|---|---|---|
| | | Examples | | | | | | | | Examples | |
| | | 1 | 2 | 3 | 4 | 5 | 6 | 7 | 8 | 1 | 2 |
| Silicone | (1-1a) | 2 | 5 | 10 | 20 | 5 | 5 | | | | |
| surfactant | (1-1b) | | | | | | | 5 | | | |
| | (1-2c) | | | | | | | | 5 | | |
| Fluorine | Hydrofluoric acid | 0.1 | 0.1 | 0.1 | 0.1 | 0.2 | | 0.1 | 0.1 | 0.2 | |
| compound | Ammonium acid fluoride | | | | | | 0.2 | | | | 0.2 |
| Organic | n-Propyl bromide | remain- | remain- | remain- | remain- | remain- | | remain- | | remain- | |
| solvent | | der | der | der | der | der | | der | | der | |
| | Isopropyl bromide | | | | | | remain- | | remain- | | remain- |
| | | | | | | | der | | der | | der |
| Evaluation | Coating film adhesion (coating | 100 | 100 | 100 | 100 | 100 | 100 | 100 | 100 | 0 | 20 |
| | film adhesion rate; %) | | | | | | | | | | |
| | Detergency | Good | Good | Good | Good | Good | Good | Good | Good | Very poor | Poor |

### INDUSTRIAL APPLICABILITY

The compound represented by Formula (1) has an excellent activity of decomposing a silicone compound and thereby solubilizing the silicone compound in an organic solvent.

The silicone-dissolvative cleaner, which contains the compound, has, in particular, excellent cleaning power on a silicone compound, can shorten the time necessary for the cleaning of the silicone compound, and contributes to dramatically better production efficiency.

The silicone-dissolvative cleaner, when containing a halogenated hydrocarbon as the organic solvent, is highly safe and easy to handle.

The silicone-dissolvative cleaner is therefore advantageously usable as a cleaner for removing a silicone compound deposited/remained on a mold and/or on a molded article obtained using the mold.

1. A compound represented by Formula (1): 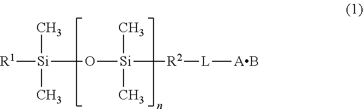
wherein R¹ represents a C₁-C₁₂ monovalent aliphatic hydrocarbon group; R² represents a C₁-C₁₂ divalent aliphatic hydrocarbon group; n represents an integer of 0 to 10; L is selected from a single bond and a linkage group; “A” represents an ionic group selected from the group consisting of the group consisting of a sulfonic ion, a carboxylic ion, and a quaternary ammonium cation; and B represents a counter-ion to “A” and is selected from an alkali metal ion and a halide ion.

2. A silicone-dissolvative cleaner comprising:
(A) a compound represented by Formula (1); and
(B) an organic solvent,
wherein Formula (1) is expressed follows: 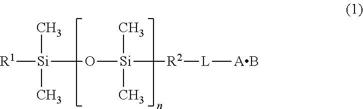
wherein R¹ represents a C₁-C₁₂ monovalent aliphatic hydrocarbon group; R² represents a C₁-C₁₂ divalent aliphatic hydrocarbon group; n represents an integer of 0 to 10; L is selected from a single bond and a linkage group; “A” represents an ionic group selected from the group consisting of a sulfonic ion, a carboxylic ion, and a quaternary ammonium cation; B represents a counter-ion to “A” and is selected from an alkali metal ion and a halide ion.

3. The silicone-dissolvative cleaner according to claim 2,
wherein the component (A) is present in a content of 1 to 60 weight percent of the totality of the silicone-dissolvative cleaner.

4. The silicone-dissolvative cleaner according to claim 2, further comprising
(C) a fluorine compound in a content of 0.001 to 10 weight percent of the totality of the silicone-dissolvative cleaner.

5. The silicone-dissolvative cleaner according to claim 4,
wherein the fluorine compound is at least one of hydrogen fluoride and a salt thereof.

6. The silicone-dissolvative cleaner according to claim 2,
wherein the organic solvent is at least one of a hydrocarbon and a halogenated hydrocarbon.

7. A method for producing a molded article using a mold coated with a silicone compound, the method comprising the step of
cleaning at least one of the resulting molded article and the mold after use, using the silicone-dissolvative cleaner according to claim 2.

8. The silicone-dissolvative cleaner according to claim 3, further comprising
(C) a fluorine compound in a content of 0.001 to 10 weight percent of the totality of the silicone-dissolvative cleaner.

9. The silicone-dissolvative cleaner according to claim 3,
wherein the organic solvent is at least one of a hydrocarbon and a halogenated hydrocarbon.

10. The silicone-dissolvative cleaner according to claim 4,
wherein the organic solvent is at least one of a hydrocarbon and a halogenated hydrocarbon.

11. The silicone-dissolvative cleaner according to claim 5,
wherein the organic solvent is at least one of a hydrocarbon and a halogenated hydrocarbon.

12. A method for producing a molded article using a mold coated with a silicone compound, the method comprising the step of
cleaning at least one of the resulting molded article and the mold after use, using the silicone-dissolvative cleaner according to claim 3.

13. A method for producing a molded article using a mold coated with a silicone compound, the method comprising the step of
cleaning at least one of the resulting molded article and the mold after use, using the silicone-dissolvative cleaner according to claim 4.

14. A method for producing a molded article using a mold coated with a silicone compound, the method comprising the step of
cleaning at least one of the resulting molded article and the mold after use, using the silicone-dissolvative cleaner according to claim 5.

15. A method for producing a molded article using a mold coated with a silicone compound, the method comprising the step of
cleaning at least one of the resulting molded article and the mold after use, using the silicone-dissolvative cleaner according to claim 6.
